(19) United States
(12) Patent Application Publication
(10) Pub. No.: US 2009/0070813 A1
(43) Pub. Date: Mar. 12, 2009

(54) Back up display system of a signal irregularity and a method of the same

(75) Inventor: Shiun-Chih Liao, Taichung (TW)

Correspondence Address: BACON & THOMAS, PLLC, 625 SLATERS LANE, FOURTH FLOOR, ALEXANDRIA, VA, 22314-1176, US

(73) Assignee: CHUNGHWA UNITED TELEVISION CO., LTD., Taichung (TW)

(21) Appl. No.: 11/896,791

(22) Filed: Sep. 6, 2007

(51) Int. Cl. G06F 3/00

(52) U.S. Cl. 725/40

(57) ABSTRACT

A back up display system of a signal irregularity and a method of the same wherein the back up display system comprises of a transmission unit acquiring an image signal; a back up display unit having a back up image information; an irregularity detecting unit detecting image information and outputting a switching signal when it determines an image signal is in irregular state; a broadcasting unit acquiring and broadcasting the image signal of the transmission unit in regular state and discontinuing to broadcast the image signal of the transmission unit by broadcasting the back up image information of the back up display unit instead when the irregularity detecting unit outputs a switching signal.

### FIELD OF THE INVENTION

The present invention relates to a back up display system and a method of the same, particularly to a back up system which switches to broadcast the other image information when the original image signal is irregular.

### BACKGROUND OF THE INVENTION

The conventional display system mostly adopts a broadcasting format that acquires an image signal directly then converts it into a broadcasting unit to provide the broadcasting unit to broadcast. When the signal acquired by the display system is in signal irregular state such as having surges, noises, unrecognizable codes or the signal content is all black or white, it has to wait until someone notices it and fixes the above mentioned signal irregularity problems. However, during the period between a signal irregularity occurs and it is restored completely, the broadcasting unit does not broadcast normally and makes viewers feel abruptly or uncomfortably in visual. Alternatively, if the broadcasting unit is switched to broadcast the other signal manually, viewers still feel abruptly or uncomfortably in visual during the period between a signal irregularity occurs and it is switched manually. Consequently, how to prevent the negative impact on viewers when the above mentioned signal irregularity occurs has been a subject that the industry aims to overcome.

### SUMMARY OF THE INVENTION

The main objective of the present invention is to switch the broadcasting unit automatically to broadcast the preset back up image information when the broadcasting signal is irregular to avoid negative impact on viewers.

To achieve the above mentioned objective the present invention provides a back up display system of a signal irregularity. It comprises of a transmission unit acquiring an image signal; a back up display unit having a back up image information; an irregularity detecting unit detecting the image signal and outputting a switching signal when it determines the image signal is in irregular state; a broadcasting unit acquiring and broadcasting the image information of the transmission unit in the regular state and discontinuing to broadcast the image signal of the transmission unit by broadcasting the back up image information of the back up display unit instead when the irregularity detecting unit outputs a switching signal.

Furthermore the present invention provides a back up display method of a signal irregularity. It comprises of a regular state broadcasting step broadcasting an image signal by utilizing a broadcasting unit; a detecting step detecting the image signal to determine whether the image signal is in regular state or not; a switching step replacing the image signal with a back up image information to broadcast the broadcasting unit after determining the image signal is irregular.

### BRIEF DESCRIPTION OF DRAWINGS

FIG. 1 is a schematic representation of the structure of an embodiment of the present invention.

FIG. 2 is a schematic flow chart of another embodiment of the present invention.

### DETAILED DESCRIPTION OF THE INVENTION

The other advantage, objective, technical feature and effectiveness of the present invention will be better understood by the detail description of preferred embodiment in conjunction with the following figure.

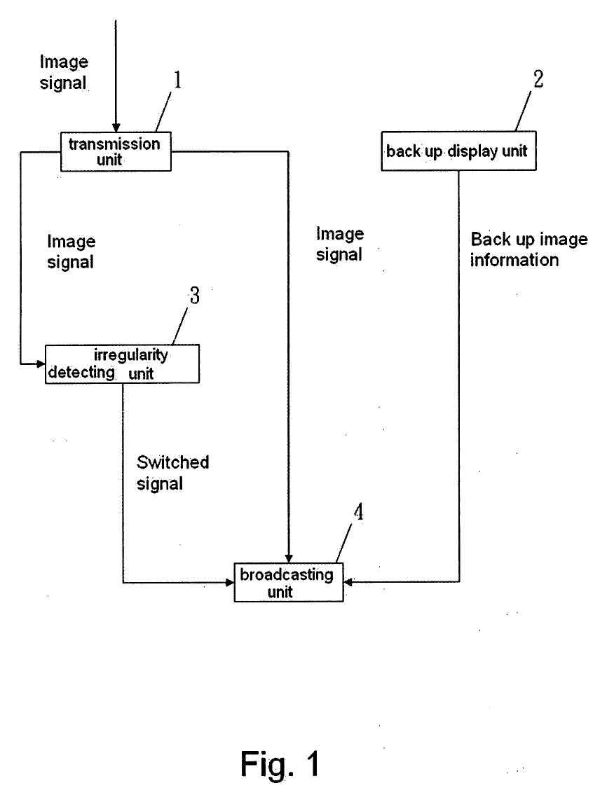

Referring to FIG. 1, the present invention provides a back up display system of a signal irregularity. It comprises of a transmission unit 1 acquiring an image signal; a back up display unit 2 having a back up image information; an irregularity detecting unit 3 detecting the image information and outputting a switching signal when it determines an irregular state exists in the image signal, wherein the irregularity detecting unit 3 is a waveform detector, noise detector or an image analyzer, the noise detector determines the image signal is in irregular state when it detects the waveform of the image signal exceeds a preset range, and the noise detector determines the image signal is in irregular state when it detects the noise margin of the image signal exceeds a preset range, the image analyzer determines the image signal is in irregular state when the implicit information of the image signal is unrecognizable code information; a broadcasting unit 4 acquiring and broadcasting the image information of the transmission unit 1 when it is in regular state and when the irregularity detecting unit 3 outputs a switching signal it discontinues to broadcast the image signal of the transmission unit 1 by broadcasting the back up image information of the back up display unit 2 instead, wherein the broadcasting unit 4 has a plurality of display blocks in a same frame and chooses either the image signal or the back up image information to broadcast in a single display block.

It is noticed that in the present embodiment the broadcasting unit 4 acquires the image signal and the back up image information concurrently and broadcasts either the image signal or back up image information by means of shielding. However, in practice the broadcasting unit 4 can merely acquire the image signal in regular state to extract the back up image information from the back up display unit 2 to broadcast after receiving the switching signal.

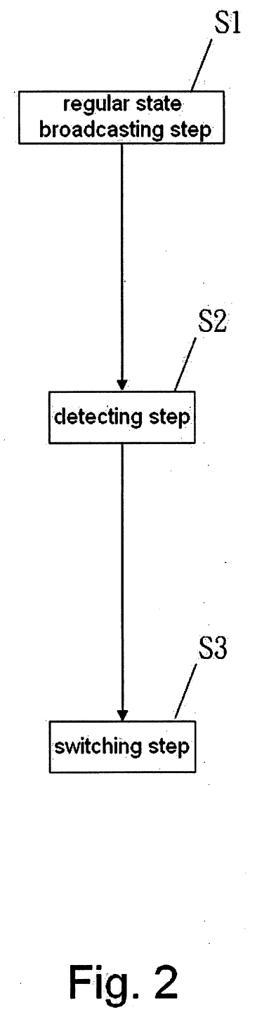

Referring to FIG. 2, furthermore the present invention provides a back up display method of a signal irregularity. It comprises of a regular state broadcasting step S1 utilizing the above mentioned broadcasting unit 4 to broadcast an image signal; a detecting step S2 detecting the image signal to determine whether the image signal is in irregularity or not wherein the detecting step applies waveform analysis, noise margin analysis or image analysis to determine whether the image signal is irregular or not; a switching step S3 replacing the image signal with a back up image information to broadcast the broadcasting unit 4 after determining the image signal is irregular, wherein the broadcasting unit 4 can apply the way that discontinues to broadcast the image signal first then broadcast the back up image information or apply the way that the broadcasting unit 4 receives the back up image information and the image signal concurrently and shields the back up image information in the regular state broadcasting step and shields the image signal in the switching step.

To sum up, by means of the back up display system of a signal irregularity of the present invention and the method of the same it can avoid the negative impacts on viewers when conventional signal irregularity occurs by instantly switching to broadcast the back up image information automatically after determining the image signal of the broadcasting unit 4 is irregular.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A back up display system of a signal irregularity comprising of:
a transmission unit acquiring an image signal;
a back up display unit having a back up image information;
an irregularity detecting unit detecting image information and outputting a switching signal when it determines an irregular state occurs in the image signal;
a broadcasting unit acquiring and broadcasting the image information of the transmission unit in regular state and discontinuing to broadcast the image signal of the transmission unit by broadcasting the back up image information of the back up display unit instead when the irregularity detecting unit outputs the switching signal.

2. A back up display system of a signal irregularity according to claim 1, wherein the broadcasting unit has a plurality of display blocks in a frame.

3. A back up display system of a signal irregularity according to claim 2, wherein the broadcasting unit selects either the image signal or the back up image information in a single display block to broadcast.

4. A back up display system of a signal irregularity according to claim 1, wherein the irregularity detecting unit is a waveform detector which determines the image signal is in irregular state when it detects the waveform of the image signal exceeds a preset range.

5. A back up display system of a signal irregularity according to claim 1, wherein the irregularity detecting unit is a noise detector which determines the image signal is in irregular state when it detects the signal margin of the image signal exceeds a preset range.

6. A back up display system of signal irregularity according to claim 1, wherein the irregularity detecting unit is an image analyzer which determines the image signal is in irregular state when it detects the implicit information of the image signal is unrecognizable code.

7. A back up display method of a signal irregularity comprising of:
a regular state broadcasting step utilizing a broadcasting unit to broadcast an image signal;
a detecting step detecting the image signal to determine whether the image signal is irregular or not;
a switching step replacing the image signal with a back up image information to broadcast at the broadcasting unit after determining the image signal is irregular.

8. A back up display method of a signal irregularity according to claim 7 wherein in the switching step the broadcasting unit discontinues to broadcast the image signal first then broadcasts the back up image information instead.

9. A back up display method of a signal irregularity according to claim 7 wherein the broadcasting unit receives the back up image information and the image signal concurrently and shields the back up image information in the regular state broadcasting step and shields the image signal in the switching step.

10. A back up display method of a signal irregularity according to claim 7 wherein the detecting step applies the following analyses such as waveform analysis, noise margin analysis and image analysis to determine whether the image signal is irregular or not.
